(19) United States
(12) Patent Application Publication
(10) Pub. No.: US 2026/0261621 A1
(43) Pub. Date: Sep. 3, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Kazunori OZEKI, Kanagawa (JP)

(73) Assignee: FUJIFILM Business Innovation Corp., Tokyo (JP)

(21) Appl. No.: 19/313,205

(22) Filed: Aug. 28, 2025

(30) Foreign Application Priority Data
Mar. 3, 2025 (JP) 2025-032661

(51) Int. Cl. H04N 1/00

(52) U.S. Cl. CPC H04N 1/00915; H04N 1/00421

(57) ABSTRACT

An information processing system includes a processor configured to: in response to an instruction from a user, set a priority function that is a function the user wants to prioritize among a group of functions of an image processing device; receive a selected function selected by the user from among a group of functions of the image processing device; and with reference to device function information that indicates functions executable by the image processing device, notify the user of whether the selected function that is not executable by the image processing device is the priority function.

### CROSS-REFERENCE TO RELATED APPLICATIONS

This application is based on and claims priority under 35 USC 119 from Japanese Patent Application No. 2025-032661 filed Mar. 3, 2025.

### BACKGROUND

### (I) Technical Field

The present disclosure relates to an information processing system and a non-transitory computer readable medium.

### (II) Related Art

An information processing system is known in which a user terminal transmits a processing command to an image processing device, causing the image processing device to execute a function. In such an information processing system of related art, when a user terminal transmits a processing command, the user is notified of a function that the image processing device does not have.

For example, Japanese Unexamined Patent Application Publication No. 2015-106263 discloses an information system including a plurality of printers serving as a plurality of image processing devices and a client terminal serving as a user terminal, in which the client terminal acquires a list of the plurality of printers and displays, in a grayed-out manner, printers for which the user cannot make desired print settings. Japanese Unexamined Patent Application Publication No. 2005-174121 discloses an information system including a network printer serving as an image processing device and a client terminal serving as a user terminal, wherein the client terminal displays, in a grayed-out manner, a function that is not executable by the network printer on a user interface (UI) of a printer driver.

### SUMMARY

When an image processing device is capable of executing multiple functions, there may be a priority function that a user wants to prioritize in the multiple functions. The priority function may differ for each user. Consider a case where an image processing device is caused to execute multiple selected functions selected by a user. In this case, even when the image processing device is incapable of executing all of the multiple selected functions, it may be beneficial for the user if the user can recognize whether the selected function that is not executable by the image processing device is a priority function of the user. For example, when the selected function that is not executable by the image processing device is not a priority function, the user may allow to use the image processing device. On the other hand, when the selected function that is not executable by the image processing device is a priority function, the user may decide not to use the image processing device.

Aspects of non-limiting embodiments of the present disclosure relate to enabling a user to recognize whether a function that is not executable by an image processing device is a priority function for the user when the image processing device is incapable of executing a plurality of selected functions selected by the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: in response to an instruction from a user, set a priority function that is a function the user wants to prioritize among a group of functions of an image processing device; receive a selected function selected by the user from among a group of functions of the image processing device; and with reference to device function information that indicates functions executable by the image processing device, notify the user of whether the selected function that is not executable by the image processing device is the priority function.

### BRIEF DESCRIPTION OF THE DRAWINGS

An exemplary embodiment of the present disclosure will be described in detail based on the following figures, wherein:

FIG. 1 is a schematic diagram of a configuration of a print system according to the present exemplary embodiment;

FIG. 2 is a schematic diagram of a configuration of a user terminal;

FIG. 3 is a diagram illustrating an example of a setting screen of frequently-used image processing devices;

FIG. 4 is a diagram illustrating an example of an image processing device selection screen;

FIG. 5 is a diagram illustrating an example of a priority function setting screen;

FIG. 6 is a diagram illustrating an example of a print settings screen;

FIG. 7 is a diagram illustrating a display example of an image processing device incapable of executing a first priority function and an image processing device incapable of executing a second priority function;

FIG. 8 is a diagram illustrating a state where image processing devices are sorted according to usage index values;

FIG. 9 is a diagram illustrating a display example of image processing devices when a selected function is not regarded as a priority function in a case where the selected function is a consumable use function that is disabled due to consumable depletion;

FIG. 10 is a diagram illustrating a display example of image processing devices when a selected function is determined to be a priority function even in the case where the selected function is a consumable use function that is disabled due to consumable depletion;

FIG. 11 is a first diagram illustrating another example of the print settings screen;

FIG. 12 is a second diagram illustrating another example of the print settings screen; and

FIG. 13 is a flowchart illustrating a flow of processing performed by the user terminal according to the present exemplary embodiment.

### DETAILED DESCRIPTION

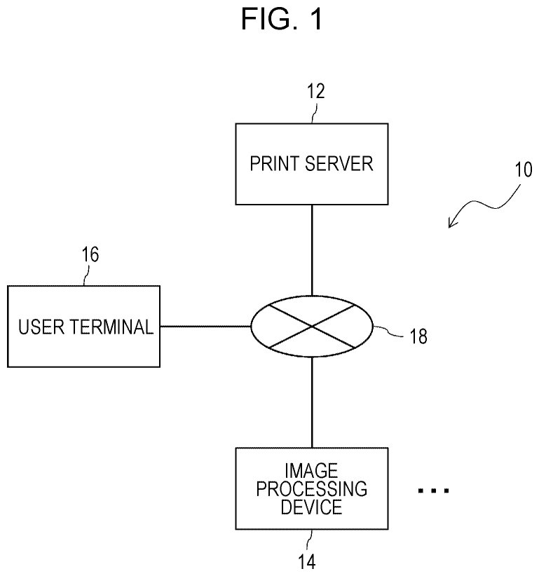

FIG. 1 is a schematic diagram of a configuration of a print system 10 according to the present exemplary embodiment. The print system 10 includes a print server 12, a plurality of image processing devices 14, and a user terminal 16 serving as an information processing system. The print server 12, the image processing devices 14, and the user terminal 16 are communicably connected to each other via a communication line 18 such as a local area network (LAN) or a wide area network (WAN).

The print server 12 is composed of, for example, a server computer or the like. The print server 12 receives a print job from the user terminal 16 and transmits the print job to the image processing device 14 in response to a request from the image processing device 14.

The image processing device 14 is a device that has a group of functions and executes processing while executing the functions in response to a processing command from a user. In the present exemplary embodiment, the image processing device 14 is, for example, a printer or a multifunction peripheral, and is a device that receives a print job serving as a processing command from a user and performs processing. When the image processing device 14 is a printer or a multifunction peripheral, examples of the group of functions of the image processing device 14 include a color printing function, a double-sided printing function, an N-UP function, a stapling function, a hole punching function, a folding function, and a booklet creation function.

The user terminal 16 is a device used by a user of the print system 10. The user terminal 16 may be, for example, a personal computer (PC), a tablet terminal, or a smartphone. Details of the user terminal 16 will be described later.

With the print system 10 according to the present exemplary embodiment, a user can select any one of the image processing devices 14 included in the print system 10 and cause the selected image processing device 14 to execute a process related to a print job. The outline of processing in the print system 10 is as follows.

First, a common printer driver supporting functions usable by all of the image processing devices 14 included in the print system 10 is installed in the user terminal 16. A user makes various print settings using the common printer driver, and transmits a print job including the set print settings and a user ID for identifying the user from the user terminal 16 to the print server 12. At this time, the user does not need to specify the image processing device 14 to execute a printing process related to the print job. The user moves to a position in front of the image processing device 14 that the user wants to cause to execute a process related to the print job, and logs in to the image processing device 14. While presenting the user ID of the user obtained by logging in, the image processing device 14 requests the print job of the user from the print server 12. When the user has transmitted multiple print jobs to the print server 12, it may be beneficial to also present information indicating the print job specified by the user. In response to the request, the print server 12 transmits the print job of the user to the image processing device 14. The image processing device 14 executes the printing process related to the received print job.

As described above, in the print system 10, since a user does not need to specify the image processing device 14 to execute a printing process related to a print job at the time when the print job is transmitted from the user terminal 16 to the print server 12, the user can select any image processing device 14 and cause it to execute a printing process related to a print job after transmitting the print job.

There may be a case where a user does not sufficiently understand the functions of each image processing device 14 included in the print system 10. In such a case, there is a possibility that the image processing device 14 that the user intends to cause to execute a process related to a print job does not have sufficient functions to execute the print job. Needless to say, in this case, the user cannot obtain a satisfactory print result. In this regard, as will be described later in detail, the present exemplary embodiment supports a user who selects the image processing device 14 to execute a print job.

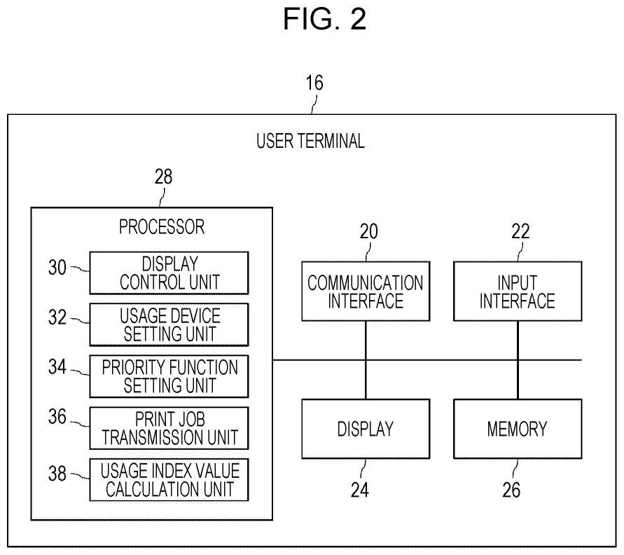

FIG. 2 is a schematic diagram of a configuration of the user terminal 16.

A communication interface 20 is composed of, for example, a network adapter or the like. The communication interface 20 executes a function of communicating with other devices, particularly with the print server 12, via the communication line 18.

An input interface 22 is composed of, for example, a keyboard, a mouse, a button, a touch panel, or the like. The input interface 22 is used when a user inputs an instruction to the user terminal 16.

A display 24 is composed of, for example, a liquid crystal display, an organic electroluminescence (EL) display, or the like. Various screens are displayed on the display 24 in response to instructions from a processor 28 (particularly, a display control unit 30) to be described later.

A memory 26 includes a hard disk drive (HDD), an embedded multimedia card (eMMC), a read only memory (ROM), a random access memory (RAM), or the like. The memory 26 stores an information processing program for causing each unit of the user terminal 16 to operate. The information processing program may be stored in, for example, a computer-readable non-transitory storage medium such as a Universal Serial Bus (USB) memory or an SD card. The user terminal 16 can read the information processing program from such a storage medium and execute the information processing program. The above-described common printer driver is installed in the memory 26.

The processor 28 is composed of, for example, a central processing unit (CPU) or the like. The processor 28 is communicably connected to the communication interface 20, the input interface 22, the display 24, and the memory 26 via a data bus. With the information processing program stored in the memory 26, the processor 28 executes the functions as the display control unit 30, a usage device setting unit 32, a priority function setting unit 34, a print job transmission unit 36, and a usage index value calculation unit 38.

The display control unit 30 performs a process of displaying various screens on the display 24. Details of the screens displayed on the display 24 by the display control unit 30 will be described later.

In accordance with an instruction from a user, the usage device setting unit 32 sets the image processing devices 14 that are frequently used by the user among the plurality of image processing devices 14 included in the print system 10. For example, when the plurality of image processing devices 14 included in the print system 10 are distributed on multiple floors of an office building and the user's room is on the third floor, the user specifies one or more image processing devices 14 on the third floor, and accordingly, the usage device setting unit 32 sets the image processing devices 14 specified by the user as the frequently-used image processing devices 14.

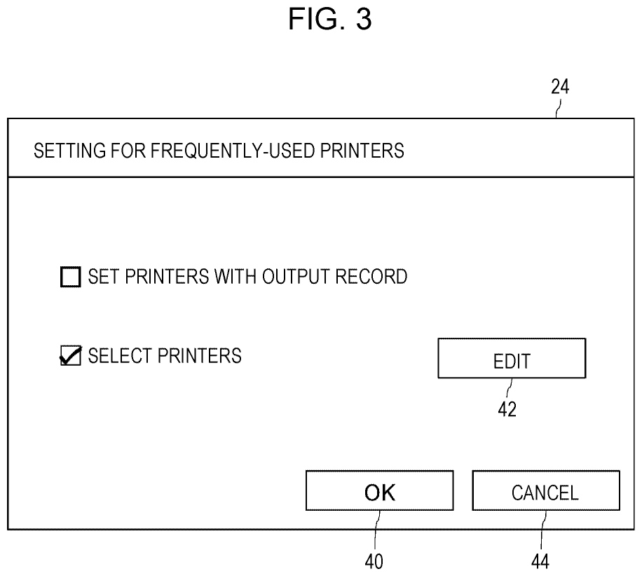

An example of a method for setting the frequently-used image processing devices 14 is as follows. When a user inputs an instruction of setting the frequently-used image processing devices 14 to the user terminal 16, the display control unit 30 causes the display 24 to display a setting screen for the frequently-used image processing devices 14, as illustrated in FIG. 3.

When the user selects “set printers with output record” (checks the checkbox) and operates an OK button 40 on the setting screen, the usage device setting unit 32 sets the image processing devices 14 used by the user in the past as the frequently-used image processing devices 14. The image processing devices 14 used by the user in the past can be acquired by referring to the processing history of print jobs accumulated and stored in the memory 26 or the print server 12. By operating a cancel button 44, the user can cancel the setting for the frequently-used image processing devices 14.

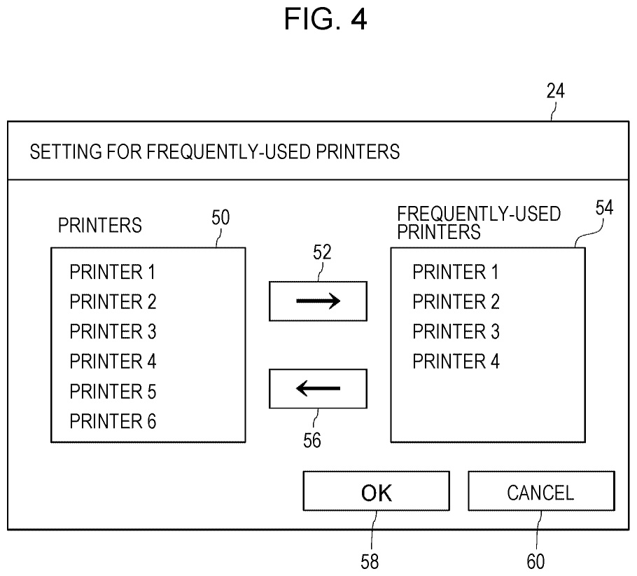

When the user selects “select printers” and operates an edit button 42 on the setting screen, the display control unit 30 causes the display 24 to display an image processing device selection screen illustrated in FIG. 4. The user can select the frequently-used image processing devices 14 on the image processing device selection screen. The image processing device selection screen includes a list 50 of the plurality of image processing devices 14 included in the print system 10. When the user selects a desired image processing device 14 from the list 50 and operates an add button 52, the selected image processing device 14 is added to a list 54 of the frequently-used image processing devices 14. By repeating such an operation, the user can select the frequently-used image processing devices 14. When the image processing device 14 is selected from the list 54 and an exclusion button 56 is operated, the image processing device 14 can be excluded from the list 54. When the user operates an OK button 58, the usage device setting unit 32 sets the image processing devices 14 included in the list 54 as the frequently-used image processing devices 14. By operating a cancel button 60, the user can return to the setting screen for the frequently-used image processing devices 14 (see FIG. 3).

The usage device setting unit 32 transmits, to the print server 12, frequently-used device information in which the user ID of the user is associated with the device IDs for identifying the frequently-used image processing devices 14 set in accordance with an instruction from the user, and causes the memory of the print server 12 to store the frequently-used device information. That is, the usage device setting unit 32 sets and stores the frequently-used image processing devices 14 for each user. The frequently-used device information may be stored in the memory 26 of the user terminal 16.

In response to an instruction from a user, the priority function setting unit 34 sets a priority function, which is a function that the user wants to prioritize, among the group of functions of the image processing devices 14 included in the print system 10.

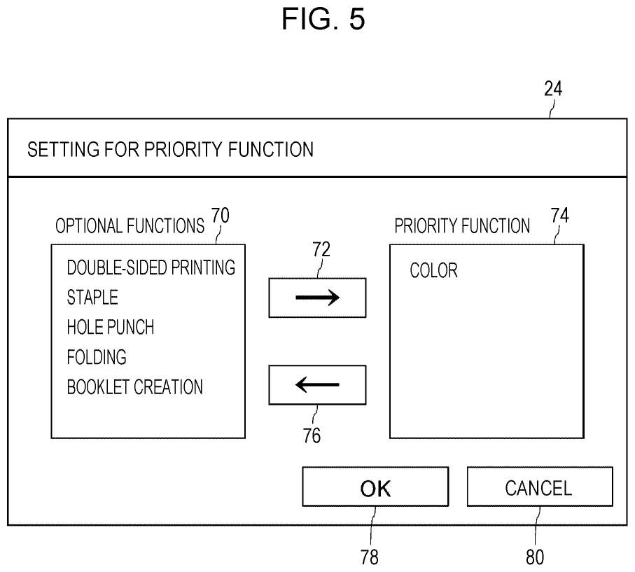

An example of a method for setting a priority function is as follows. When a user inputs an instruction of setting a priority function to the user terminal 16, the display control unit 30 causes the display 24 to display a priority function setting screen as illustrated in FIG. 5.

The user can select a priority function on the priority function setting screen. The priority function setting screen includes a list 70 of the functions of the plurality of image processing devices 14 included in the print system 10. The print server 12 has information indicating functions executable by each image processing device 14. By the user terminal 16 receiving such information from the print server 12, the display control unit 30 can acquire the functions of the plurality of image processing devices 14 included in the print system 10. When the user selects a desired function from the list 70 and operates an add button 72, the selected function is added to a list 74 of priority functions. By repeating such an operation, the user can select a priority function. The user may be able to select multiple priority functions. When a function is selected from the list 74 and an exclusion button 76 is operated, the function can be excluded from the list 74. When the user operates an OK button 78, the priority function setting unit 34 sets the functions included in the list 74 as priority functions. By operating a cancel button 80, the user can cancel the setting for a priority function.

In response to an instruction from the user, the priority function setting unit 34 may assign priorities to multiple priority functions and set the priority functions in a stepwise manner. That is, the priority function setting unit 34 may set multiple stages of priority functions including a first priority function and a second priority function that the user wants to prioritize next to the first priority function. As a method for setting multiple stages of priority functions, for example, the user may be allowed to select multiple stages of priority functions including the first priority function and the second priority function from among the functions displayed in the list 70 on the priority function setting screen illustrated in FIG. 5.

The priority function setting unit 34 transmits, to the print server 12, priority function information in which the user ID of the user is associated with the priority function set in accordance with an instruction from the user, and causes the memory of the print server 12 to store the priority function information. That is, the priority function setting unit 34 sets and stores a priority function for each user. The priority function information may be stored in the memory 26 of the user terminal 16.

The print job transmission unit 36 receives print settings from a user, and transmits a print job containing the set print settings and a user ID for identifying the user to the print server 12. The following describes the details of processing performed when print settings are made in the user terminal 16.

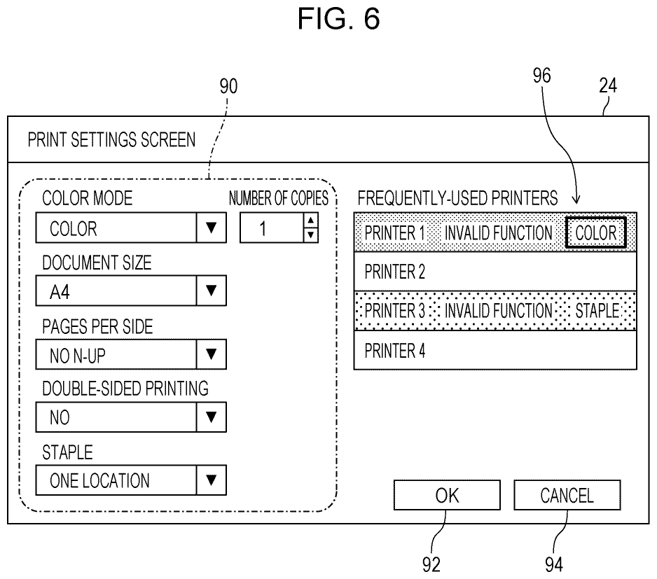

When a user inputs a print instruction to the user terminal 16, the display control unit 30 causes the display 24 to display a print settings screen as illustrated in FIG. 6. The print settings screen includes a print settings input area 90 for inputting print settings related to a print job. In the print settings input area 90, for example, the user inputs a setting value for each setting item such as color mode, number of copies, document size, pages per side, double-sided printing, or staple. By inputting a setting value for each setting item, the user selects a function of the image processing device 14. For example, when the user selects “color” as a value for the setting item “color mode”, it means that the user has selected the color printing function of the image processing device 14. For example, when the user selects “one location” as a value for the setting item “staple”, it means that the user has selected the stapling function of the image processing device 14. As described above, the print settings input area 90 receives a function selected by the user from among the group of functions of the image processing device 14. In this specification, a function selected by a user on the print settings screen is referred to as a “selected function”.

When the user operates an OK button 92 after inputting the print settings, the print job transmission unit 36 transmits a print job containing the input print settings and a user ID for identifying the user to the print server 12. By operating a cancel button 94, the user can cancel transmission of the print job.

Based on the above-described frequently-used device information, the display control unit 30 causes a list 96 of the image processing devices 14 frequently used by the user to be displayed on the print settings screen. With regard to the list 96, the display control unit 30 displays the image processing device 14 capable of executing the selected function input by the user and the image processing device 14 incapable of executing the selected function in different modes.

Functions executable by each image processing device 14 may be aggregated in advance in the print server 12. Specifically, the print server 12 may store device function information in which a device ID for identifying each image processing device 14 included in the print system 10, a device name, and functions executable by the image processing device 14 are associated with each other. The user terminal 16 acquires the device function information from the print server 12 in advance or at a timing when a print instruction is received from the user. With reference to the device function information, the display control unit 30 can recognize functions that are executable (in other words, functions that are not executable) by each image processing device 14. The user terminal 16 may acquire the device function information by a method other than the above-described method. For example, the user terminal 16 may transmit an inquiry to each image processing device 14 to acquire functions executable by each image processing device 14.

In the example illustrated in FIG. 6, the user has selected the color printing function and the stapling function as selected functions. Therefore, in the list 96, the display control unit 30 causes the image processing device 14 capable of executing both the color printing function and the stapling function and the image processing device 14 incapable of executing at least one of the color printing function and the stapling function to be displayed in different modes. Specifically, the display control unit 30 causes printers 2 and 4 capable of executing the color printing function and the stapling function to be displayed without shading, and causes printers 1 and 3 incapable of executing the color printing function or the stapling function to be displayed with shading. The difference in display mode is not limited to the presence or absence of shading.

With the image processing device 14 capable of executing the selected function input by the user and the image processing device 14 incapable of executing the selected function displayed in different modes, the user can easily recognize the image processing device 14 capable of appropriately processing his/her print job before going to the image processing device 14. With this configuration, the user can cause the image processing device 14 capable of appropriately processing his/her print job to process the print job.

When multiple selected functions are selected by the user, the display control unit 30 may notify the user of a function that is not executable by the image processing device 14. For example, in the example illustrated in FIG. 6, it is assumed that the printer 1 is incapable of executing the color printing function but is capable of executing the stapling function, and the printer 3 is capable of executing the color printing function but is incapable of executing the stapling function. In this case, in the list 96, the display control unit 30 shades the printer 1 and displays that the color printing function is not executable by the printer 1, and shades the printer 3 and displays that the stapling function is not executable by the printer 3.

When the user selects multiple selected functions, simply displaying the image processing device 14 capable of executing the selected functions and the image processing device 14 incapable of executing the selected functions in different modes does not allow the user to recognize which of the selected functions the image processing devices 14 are incapable of executing. By notifying the user of a function that is not executable by the image processing device 14 as described above, the user can easily recognize the selected function that is not executable by the image processing device 14.

The display control unit 30 may not only cause the image processing device 14 capable of executing a selected function and the image processing device 14 incapable of executing the selected function to be displayed in different modes, but also notify the user of whether the selected function that is not executable by the image processing device 14 is a priority function.

Specifically, based on the above-described priority function information, the display control unit 30 determines whether a selected function that is not executable by the image processing device 14 is a priority function of the user, and when the selected function is a priority function, notifies the user. In the example illustrated in FIG. 6, it is assumed that the color printing function serving as a selected function is a priority function, and the stapling function serving as a selected function is not a priority function. Since the printer 1 is incapable of executing the color printing function, which is a priority function, the display control unit 30 causes a thick frame surrounding the word “color” to be displayed in the list 96 so as to emphasize the word “color”, which is a function that is not executable by the printer 1. By doing so, the display control unit 30 notifies the user that the selected function that is not executable by the printer 1 is a priority function. Needless to say, the method of notifying that a selected function that is not executable by the image processing device 14 is a priority function is not limited to this. For example, the word “color” may be displayed in a color different from the others.

As a result, the user can easily recognize the image processing device 14 that cannot execute the priority function. As a result, when the user wants the image processing device 14 to always execute a process related to the priority function, the user can cause another image processing device 14 to process his/her print job while avoiding the image processing device 14 that cannot execute the priority function.

When multiple selected functions are selected by the user and there is a plurality of image processing devices 14 incapable of executing at least one of the multiple selected functions, the display control unit 30 may cause the image processing device 14 incapable of executing the priority function and the image processing device 14 capable of executing the priority function (in other words, incapable of executing selected functions other than the priority function) to be displayed in different modes, among the plurality of image processing devices 14.

For example, in the example illustrated in FIG. 6, since the printer 1 is incapable of executing the color printing function, which is a priority function, and the printer 3 is capable of executing the color printing function, the display control unit 30 causes the printer 1 and the printer 3 to be displayed in different modes in the list 96. In the example illustrated in FIG. 6, the printer 1 is displayed with dark shading, and the printer 3 is displayed with light shading. Also in this case, the difference in display mode is not limited to the density of shading.

In a case where selected functions that are not executable by the image processing device 14 are displayed in the list 96, and the selected functions that are not executable are highlighted when the functions are priority functions (for example, in the case where a thick frame surrounding the word “color”, which is a selected function that is not executable by the printer 1, is displayed in FIG. 6), the image processing device 14 incapable of executing the priority function and the image processing device 14 capable of executing the priority function are displayed in different modes even with the highlighted display.

When the user wants the image processing device 14 to always execute a process related to the priority function but does not necessarily want the image processing device 14 to execute a process related to a selected function other than the priority function, the user can cause the image processing device 14 that is incapable of executing the selected functions other than the priority function but is capable of executing the priority function to process his/her print job. For example, when there is no image processing device 14 capable of executing all of the selected functions in the frequently-used image processing devices 14, the user can cause the image processing device 14 that is incapable of executing the selected functions other than the priority function but is capable of executing the priority function to process his/her print job.

When multiple stages of priority functions including a first priority function and a second priority function are set by the priority function setting unit 34, the display control unit 30 may cause the image processing device 14 incapable of executing the first priority function and the image processing device 14 capable of executing the first priority function but incapable of executing the second priority function to be displayed in different modes, among the plurality of image processing devices 14 incapable of executing at least one of the multiple selected functions.

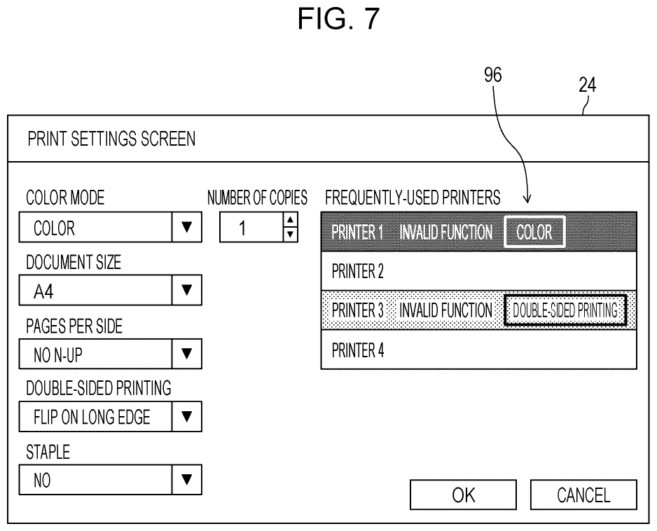

For example, in the example illustrated in FIG. 7, it is assumed that the color printing function and the double-sided printing function are selected as selected functions, the color printing function is the first priority function, and the double-sided printing function is the second priority function. In this case, in the list 96, the display control unit 30 causes the printer 3, which is incapable of executing the double-sided printing function serving as the second priority function, to be displayed with dark shading, and causes the printer 1, which is incapable of executing the color printing function serving as the first priority function, to be displayed with darker shading than the printer 3.

With the image processing device 14 incapable of executing the first priority function and the image processing device 14 capable of executing the first priority function but incapable of executing the second priority function displayed in different modes, the user can easily recognize the image processing device 14 incapable of executing a priority function with a higher priority level in the image processing devices 14 incapable of executing priority functions.

Referring back to FIG. 2, the usage index value calculation unit 38 calculates a usage index value for each of the frequently-used image processing devices 14. The usage index value is an index indicating how suitable the image processing device 14 is for use by a user who has selected a selected function.

In the present exemplary embodiment, the usage index value calculation unit 38 calculates a usage index value such that the usage index value decreases as the number of selected functions that are not executable by the image processing device 14 increases, and the usage index value decreases more when the selected function that is not executable by the image processing device 14 is a priority function than when the selected function is not a priority function. For example, the usage index value calculation unit 38 calculates a usage index value by the following Formula (1).
Usage index value=(the number of priority functions that are not executable)*(−5)+(the number of selected functions that are not executable other than priority functions)* (−2) . . . (1)
According to Formula (1), the maximum value of usage index value is 0, and a smaller value indicates that the image processing device 14 is less suitable for use by the user who has selected the selected function.

The usage index value calculation unit 38 may further calculate a usage index value based on the distance between the installation location of the image processing device 14 and the user terminal 16. Specifically, the usage index value calculation unit 38 may calculate a usage index value of the image processing device 14 such that the value decreases with increasing distance from the user terminal 16 to the installation location of the image processing device 14. Information indicating the installation location of the image processing device 14 (for example, position coordinates) may be acquired in advance and stored in the print server 12 in association with a device ID for identifying the image processing device 14. The information indicating the installation location of the image processing device 14 (for example, position coordinates) may be included in the above-described device function information. The user terminal 16 acquires the information indicating the installation location of the image processing device 14 from the print server 12. When the user terminal 16 is a stationary device, information indicating the position of the user terminal 16 may be acquired in advance and stored in the memory 26. When the user terminal 16 is a portable terminal, the information indicating the position of the user terminal 16 may be acquired by a position information acquisition function (for example, a GPS function) of the user terminal 16.

The usage index value calculation unit 38 may further calculate a usage index value based on the usage waiting time of the image processing device 14. Specifically, the usage index value calculation unit 38 may calculate a usage index value such that the value is smaller as the usage waiting time of the image processing device 14 is longer. The usage waiting time is time required to complete all the processes related to a processing command transmitted to the image processing device 14. In the print system 10, since print jobs from users are aggregated in the print server 12, the print server 12 can calculate time required for processing related to each print job by analyzing the details of the print job received from the user terminal 16, and can also recognize the image processing device 14 that is the transmission destination of each print job. Therefore, the print server 12 can calculate the usage waiting time of each image processing device 14. The user terminal 16 acquires information indicating the usage waiting time of each image processing device 14 from the print server 12.

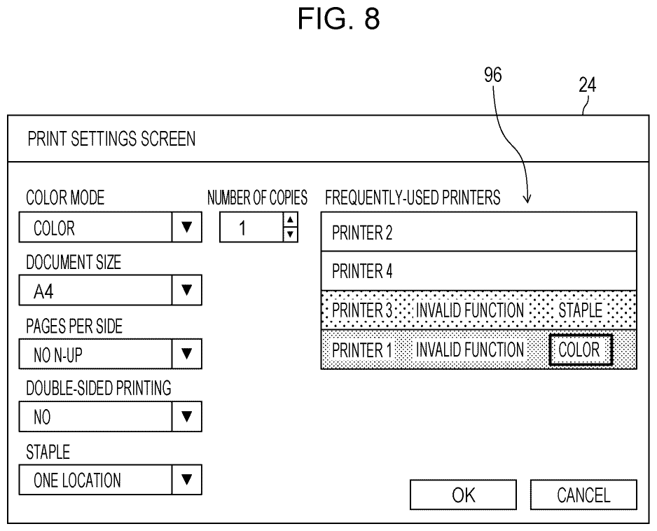

The display control unit 30 may cause the plurality of image processing devices 14 to be displayed in such modes that the magnitude relationship between the usage index values of the image processing devices 14 calculated by the usage index value calculation unit 38 can be identified. For example, with reference to FIG. 8, it is assumed that the printers 2 and 4 are capable of executing all of the selected functions, the printer 3 is incapable of executing one of the selected functions other than the priority functions, and the printer 1 is incapable of executing one of the priority functions. In this case, the usage index values of the printers 2 and 4 are 0, the usage index value of the printer 3 is −2, and the usage index value of the printer 1 is −5. Therefore, as illustrated in FIG. 8, the display control unit 30 sorts and displays the printers in descending order of usage index values in the list 96, that is, in the order of the printers 2, 4, 3, and 1. The method of displaying the magnitude relationship between usage index values is not limited to sorting. For example, the display control unit 30 may cause the usage index values of the image processing devices 14 to be displayed in the list 96.

With the plurality of image processing devices 14 displayed in such modes that the magnitude relationship between the usage index values of the image processing devices 14 can be identified, the user can easily recognize the image processing device 14 suitable for use.

The image processing device 14 may have a function that is disabled due to consumable depletion (referred to as a “consumable use function” in the present specification). Examples of consumables include staples and toner. For example, when staples run out, the image processing device 14 is incapable of executing the stapling function, which is a consumable use function, and when color toners run out, the image processing device 14 is incapable of executing the color printing function, which is a consumable use function.

While the image processing device 14 is incapable of executing a consumable use function when in a state of consumable depletion, it goes without saying that once replenished with consumables, the image processing device 14 is capable of executing the consumable use function again. Therefore, when a selected function that is not executable by the image processing device 14 is a priority function but the selected function is a consumable use function that is disabled due to consumable depletion, the display control unit 30 may regard the selected function as not being a priority function. Information indicating the stock state of consumables in the image processing device 14 may be periodically transmitted from the image processing device 14 to the print server 12. The information indicating the stock state of consumables in the image processing device 14 may be included in the above-described device function information. The user terminal 16 acquires, from the print server 12, the information indicating the stock state of consumables in the image processing device 14. Alternatively, the user terminal 16 may directly inquire of each image processing device 14 about the stock state of consumables.

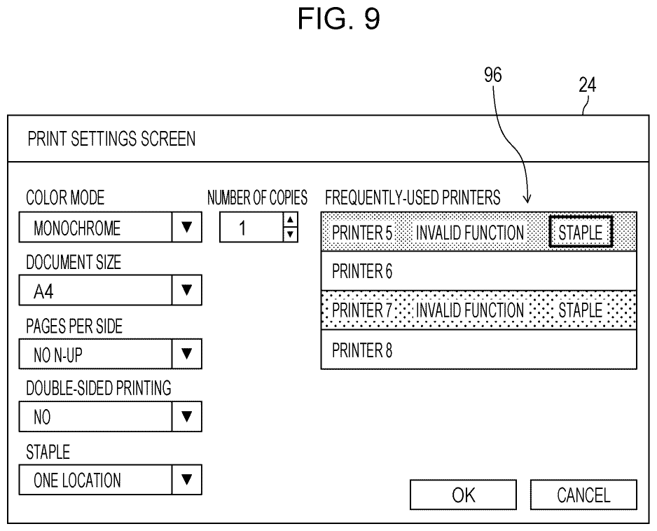

For example, in the example illustrated in FIG. 9, it is assumed that the stapling function is selected as a selected function, the stapling function is selected as a priority function, a printer 5 does not have the stapling function in the first place, and a printer 7 has the stapling function but has run out of staples serving as consumables. In this case, in the list 96, the display control unit 30 causes the printer 5 to be displayed with dark shading since the printer 5 is the image processing device 14 incapable of executing the priority function, but assumes that the printer 7 is not the image processing device 14 incapable of executing the priority function, and causes the printer 7 to be displayed in the same mode as the image processing device 14 incapable of executing selected functions other than the priority function, that is, with light shading.

When a selected function that is not executable by the image processing device 14 is a priority function but the selected function is a consumable use function that is disabled due to consumable depletion, the usage index value calculation unit 38 may also regard the selected function as not being a priority function and calculate a usage index value.

Note that not all consumable use functions need to be handled as described above. For example, staples and the like are easy to replenish and may be handled as described above, but color toners and the like take time to replenish or cannot be easily replenished by a user. Therefore, even when the selected function that is not executable by the image processing device 14 is a priority function and a consumable use function that is disabled due to consumable depletion, the display control unit 30 and the usage index value calculation unit 38 may regard the selected function as a priority function as usual.

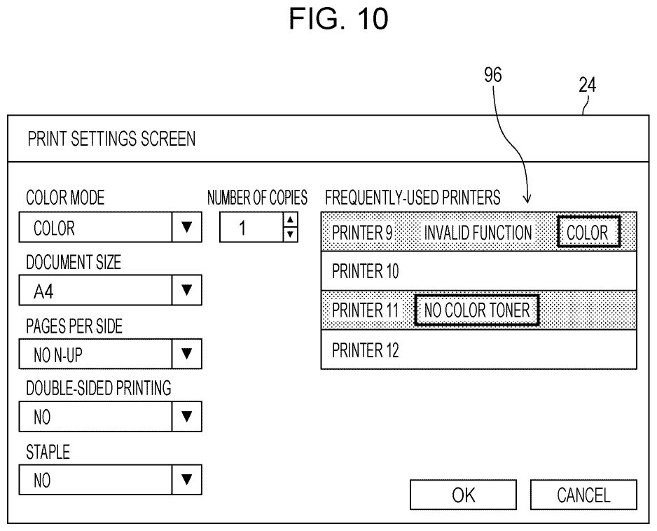

For example, in the example illustrated in FIG. 10, it is assumed that the color printing function is selected as a selected function, the color printing function is selected as a priority function, a printer 9 does not have the color printing function in the first place, and a printer 11 has the color printing function but has run out of color toner serving as a consumable. In this case, in the list 96, the display control unit 30 causes the printers 9 and 11 to be displayed with dark shading since both of the printers 9 and 11 are the image processing devices 14 incapable of executing the priority function.

A consumable use function that is not regarded as a priority function may be determined in advance and stored in the memory of the print server 12 or the memory 26 of the user terminal 16.

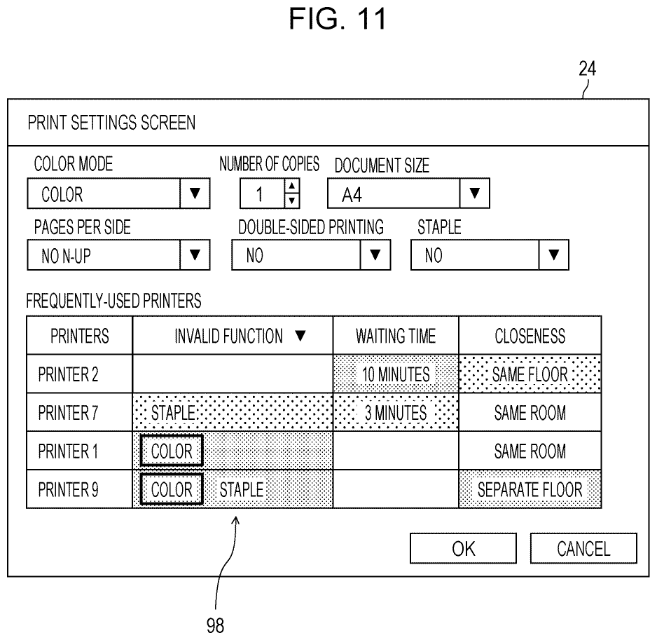

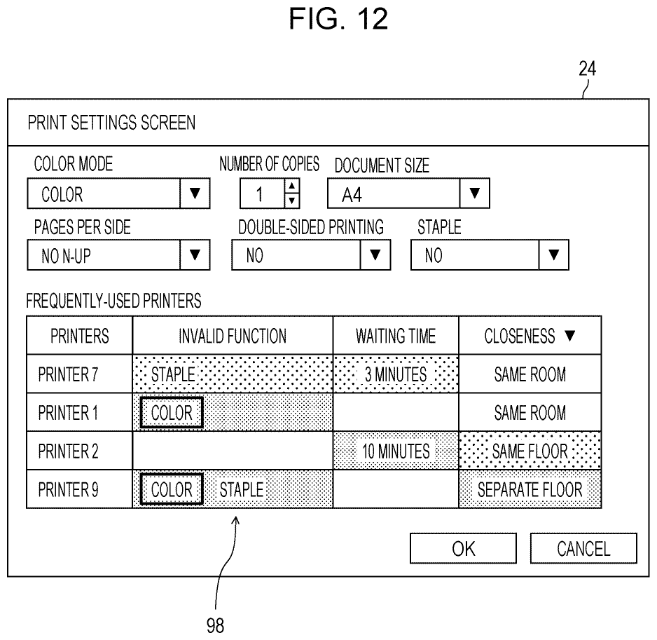

FIG. 11 is a diagram illustrating another example of the print settings screen. As illustrated in FIG. 11, the display control unit 30 may cause at least one of the usage waiting time of the image processing device 14 and the closeness between the user terminal 16 and the installation location of the image processing device 14 to be displayed in a list 98 of the image processing devices 14, in addition to the image processing device 14 and the selected functions that are not executable by the image processing device 14. In the list 98, a user may be able to sort and display the image processing devices 14 by desired items. For example, the example illustrated in FIG. 11 is an instance where the display control unit 30 sorts and displays the image processing devices 14 in ascending order based on the number of selected functions that are not executable by the image processing device 14 in response to a user instruction, and the example illustrated in FIG. 12 is an instance where the display control unit 30 sorts and displays the image processing devices 14 in the order of closeness between the user terminal 16 and the installation location of the image processing device 14 in response to a user instruction.

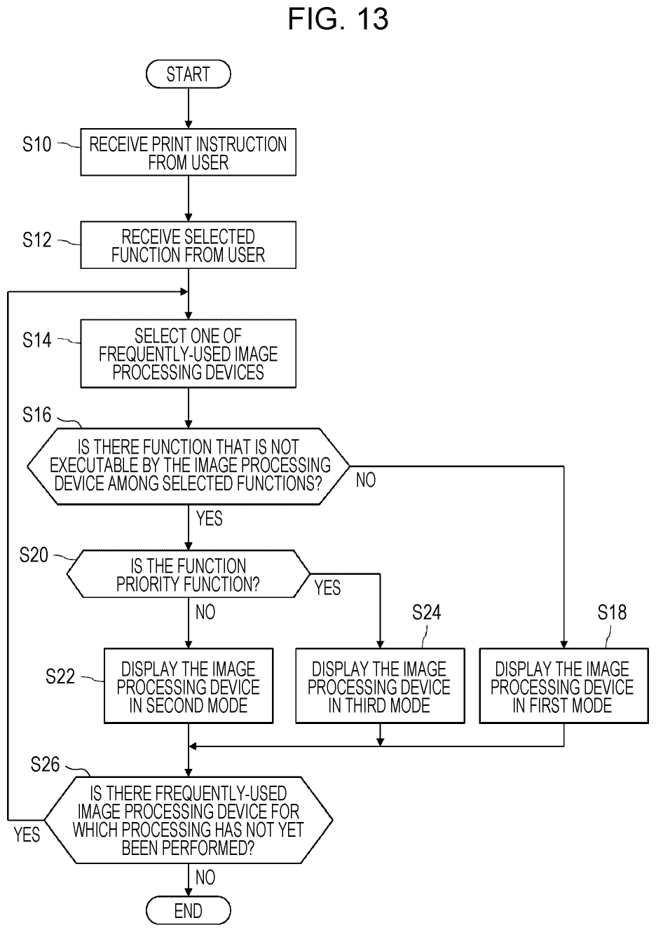

The overview of the print system 10 according to the present exemplary embodiment is as described above. With reference to the flowchart illustrated in FIG. 13, the following describes the flow of processing performed by the user terminal 16 in the present exemplary embodiment. At the start of the flowchart illustrated in FIG. 13, the image processing devices 14 frequently used by a user have been set by the usage device setting unit 32, and a priority function of the user has also been set by the priority function setting unit 34.

In step S10, the print job transmission unit 36 receives a print instruction from a user.

In step S12, the display control unit 30 causes the display 24 to display a print settings screen, and the user inputs print settings in the print settings input area 90 included in the print settings screen. As a result, the print job transmission unit 36 receives selected functions from the user.

In step S14, the display control unit 30 selects one of the image processing devices 14 frequently used by the user.

In step S16, the display control unit 30 determines whether there is a function that is not executable by the image processing device 14 selected in step S14 among the selected functions received in step S12. When the image processing device 14 is capable of executing all of the selected functions (“No” in step S16), the processing proceeds to step S18.

In step S18, the display control unit 30 causes the image processing device 14 to be displayed in a first mode in the list 96 on the print settings screen. For example, as illustrated in FIG. 6, the display control unit 30 causes the image processing device 14 to be displayed without shading.

When the image processing device 14 is incapable of executing any of the selected functions in step S16 (“Yes” in step S16), the processing proceeds to step S20.

In step S20, the display control unit 30 determines whether the selected function that is not executable by the image processing device 14 is a priority function. When the selected function that is not executable by the image processing device 14 is not a priority function (“No” in step S20), the processing proceeds to step S22.

In step S22, the display control unit 30 causes the image processing device 14 to be displayed in a second mode different from the first mode in the list 96 on the print settings screen. For example, as illustrated in FIG. 6, the display control unit 30 causes the image processing device 14 to be displayed with light shading. The display control unit 30 causes the selected function that is not executable by the image processing device 14 to be displayed.

When the selected function that is not executable by the image processing device 14 is a priority function (“Yes” in step S20), the processing proceeds to step S24.

In step S24, the display control unit 30 causes the image processing device 14 to be displayed in a third mode different from the first mode and the second mode in the list 96 on the print settings screen. For example, as illustrated in FIG. 6, the display control unit 30 causes the image processing device 14 to be displayed with dark shading. The display control unit 30 causes the selected function (priority function) that is not executable by the image processing device 14 to be displayed with bold frames.

In step S26, the display control unit 30 determines whether there is a frequently-used image processing device 14 for which the processing of steps S14 to S24 has not yet been performed. When there is such a device (“Yes” in step S26), the processing returns to step S14, and in the repeated step S14, the display control unit 30 selects one of the frequently-used image processing devices 14 for which the processing has not yet been performed. When there is no such device (“No” in step S26), the processing ends.

While the exemplary embodiment according to the present disclosure has been described above, the present disclosure is not limited to the above exemplary embodiment, and various modifications can be made without departing from the spirit of the present disclosure.

For example, while the above exemplary embodiment relates to a case where the print system 10 includes the plurality of image processing devices 14, the print system 10 may include a single image processing device 14.

While the above exemplary embodiment relates to a case where the image processing device 14 is a printer or a multifunction peripheral, the image processing device 14 may be a device other than a printer or a multifunction peripheral. The image processing device 14 may be any device as long as it has a group of functions and can execute a function selected by a user.

While the above exemplary embodiment relates to a case where a notification as to whether a selected function that is not executable by the image processing device 14 is a priority function is provided in the list 96 on the print settings screen (see FIG. 6), the display control unit 30 may provide such a notification on another screen.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is also applicable to a program and a program product.

### Appendix

(((1)))
An information processing system comprising:
a processor configured to:
in response to an instruction from a user, set a priority function that is a function the user wants to prioritize among a group of functions of an image processing device;
receive a selected function selected by the user from among a group of functions of the image processing device; and
with reference to device function information that indicates functions executable by the image processing device, notify the user of whether the selected function that is not executable by the image processing device is the priority function.

(((2)))
The information processing system according to (((1))), wherein when the selected function is one of a plurality of functions selected by the user, the processor is configured to notify the user of each function that is not executable by the image processing device.

(((3)))
The information processing system according to (((1))) or (((2))), wherein
a plurality of the image processing devices are provided, and
the processor is configured to cause the image processing device incapable of executing the priority function and the image processing device capable of executing the priority function to be displayed in a display unit in different modes, among a plurality of the image processing devices incapable of executing a plurality of the selected functions.

(((4)))
The information processing system according to (((3))), wherein
the processor is configured to:
set multiple stages of the priority function that include a first priority function and a second priority function that the user wants to prioritize next to the first priority function; and
cause the image processing device incapable of executing the first priority function and the image processing device capable of executing the first priority function but incapable of executing the second priority function to be displayed in a display unit in different modes, among a plurality of the image processing devices incapable of executing a plurality of the selected functions.

(((5)))
The information processing system according to (((3))) or (((4))), wherein
the processor is configured to:
calculate, for each image processing device, a usage index value that decreases as a number of selected functions that are not executable by the image processing device increases and that decreases more when the selected function that is not executable by the image processing device is the priority function than when the selected function is not the priority function; and
cause a plurality of the image processing devices to be displayed in the display unit in such a mode that a magnitude relationship of the usage index value of each image processing device can be identified.

(((6)))
The information processing system according to (((5))), wherein
the processor is configured to calculate the usage index value such that the usage index value decreases with increasing distance from a user terminal used by the user to an installation location of the image processing device.

(((7)))
The information processing system according to (((5))) or (((6))), wherein
the processor is configured to calculate the usage index value such that the usage index value is smaller as usage waiting time of the image processing device is longer.

(((8)))
The information processing system according to (((1))) or (((2))), wherein
the image processing device has a consumable use function that is disabled due to consumable depletion, and
when the selected function that is not executable by the image processing device is the priority function but the selected function is the consumable use function that is disabled due to consumable depletion, the processor is configured to regard the selected function as not being the priority function.

(((9)))
A program causing a computer to execute a process for information processing, the process comprising:
in response to an instruction from a user, setting a priority function that is a function the user wants to prioritize among a group of functions of an image processing device;
receiving a selected function selected by the user from among a group of functions of the image processing device; and
with reference to device function information that indicates functions executable by the image processing device, notifying the user of whether the selected function that is not executable by the image processing device is the priority function.

What is claimed is:

1. An information processing system comprising:
a processor configured to:
in response to an instruction from a user, set a priority function that is a function the user wants to prioritize among a group of functions of an image processing device;
receive a selected function selected by the user from among a group of functions of the image processing device; and
with reference to device function information that indicates functions executable by the image processing device, notify the user of whether the selected function that is not executable by the image processing device is the priority function.

2. The information processing system according to claim 1, wherein
when the selected function is one of a plurality of functions selected by the user, the processor is configured to notify the user of each function that is not executable by the image processing device.

3. The information processing system according to claim 1, wherein
a plurality of the image processing devices are provided, and
the processor is configured to cause the image processing device incapable of executing the priority function and the image processing device capable of executing the priority function to be displayed in a display unit in different modes, among a plurality of the image processing devices incapable of executing a plurality of the selected functions.

4. The information processing system according to claim 3, wherein
the processor is configured to:
set multiple stages of the priority function that include a first priority function and a second priority function that the user wants to prioritize next to the first priority function; and
cause the image processing device incapable of executing the first priority function and the image processing device capable of executing the first priority function but incapable of executing the second priority function to be displayed in a display unit in different modes, among a plurality of the image processing devices incapable of executing a plurality of the selected functions.

5. The information processing system according to claim 3, wherein
the processor is configured to:
calculate, for each image processing device, a usage index value that decreases as a number of selected functions that are not executable by the image processing device increases and that decreases more when the selected function that is not executable by the image processing device is the priority function than when the selected function is not the priority function; and
cause a plurality of the image processing devices to be displayed in the display unit in such a mode that a magnitude relationship of the usage index value of each image processing device can be identified.

6. The information processing system according to claim 4, wherein
the processor is configured to:
calculate, for each image processing device, a usage index value that decreases as a number of selected functions that are not executable by the image processing device increases and that decreases more when the selected function that is not executable by the image processing device is the priority function than when the selected function is not the priority function; and
cause a plurality of the image processing devices to be displayed in the display unit in such a mode that a magnitude relationship of the usage index value of each image processing device can be identified.

7. The information processing system according to claim 5, wherein
the processor is configured to calculate the usage index value such that the usage index value decreases with increasing distance from a user terminal used by the user to an installation location of the image processing device.

8. The information processing system according to claim 5, wherein
the processor is configured to calculate the usage index value such that the usage index value is smaller as usage waiting time of the image processing device is longer.

9. The information processing system according to claim 1, wherein
the image processing device has a consumable use function that is disabled due to consumable depletion, and
when the selected function that is not executable by the image processing device is the priority function but the selected function is the consumable use function that is disabled due to consumable depletion, the processor is configured to regard the selected function as not being the priority function.

10. The information processing system according to claim 2, wherein
the image processing device has a consumable use function that is disabled due to consumable depletion, and
when the selected function that is not executable by the image processing device is the priority function but the selected function is the consumable use function that is disabled due to consumable depletion, the processor is configured to regard the selected function as not being the priority function.

11. A non-transitory computer readable medium storing a program causing a computer to execute a process for information processing, the process comprising:
in response to an instruction from a user, setting a priority function that is a function the user wants to prioritize among a group of functions of an image processing device;
receiving a selected function selected by the user from among a group of functions of the image processing device; and
with reference to device function information that indicates functions executable by the image processing device, notifying the user of whether the selected function that is not executable by the image processing device is the priority function.
